(19) United States
(12) Patent Application Publication
(10) Pub. No.: US 2012/0053970 A1
(43) Pub. Date: Mar. 1, 2012

(54) SYSTEMS AND METHODS FOR DYNAMIC COMPOSITION OF BUSINESS PROCESSES

(75) Inventors: Anuradha Bhamidipaty, Bangalore (IN); Bhuvan Sharma, Bangalore (IN); Virendra K. Varshneya, Aligarh (IN)

(73) Assignee: INTERNATIONAL BUSINESS MACHINES CORPORATION, Armonk, NY (US)

(21) Appl. No.: 12/868,221

(22) Filed: Aug. 25, 2010

(51) Int. Cl. G06Q 10/00

(52) U.S. Cl. 705/7.11

(57) ABSTRACT

Systems and associated methods for dynamic, selection of services for business processes are described. Systems and methods manage problems related to service selection for business processes in a shared environment and manage the end-to-end QoS requirements for multiple business processes that access a shared environment. A solution is provided to such problems by discovering set(s) of service designs/selections using a combinatorial selection technique, such as for example a population-based selection technique. The systems and methods described herein can automatically determine changes to the system, determine a new set of service design selection solutions, and reconfigure the system accordingly.

### BACKGROUND

Cloud computing allows shared resources such as software implemented services supporting business processes to be provided to computers and/or other devices on demand. Business users are among those taking advantage of cloud computing environments in order to share services among various business processes used by the enterprise.

A shared services environment has significant advantages for businesses. For example, a shared services environment can help reduce IT costs and streamline an organization's functions. A shared services environment is for example a collection of services supporting various business processes in an on-demand, cloud-based computing environment. As a non-limiting example, a private cloud may host multiple services (for example, yellow pages search service, customer credit check service, Lightweight Directory Access Protocol (LDAP) service, user profile search service, et cetera) on its cloud platform. The shared services environment offers users different choices as to services that support various processes.

Shared services environment enables an organization to reuse services across groups and thus streamlines the organization's functions such that the services are delivered as efficiently and effectively as possible. In such shared services environments, similar services are made available with different quality of service (QoS) parameters to meet varying objectives of the business processes that consume these services. Business process owners typically specify QoS requirements for the individual activities within a process in addition to QoS for end-to-end process execution.

### BRIEF SUMMARY

The subject matter described herein generally relates to systems and methods that manage problems related to service selection for business processes in a shared environment and for managing the end-to-end QoS requirements for multiple business processes that access a shared environment. Embodiments provide a solution to such problems by discovering set(s) of service designs/selections using a combinatorial selection technique, such as for example a population-based selection technique. Embodiments can automatically determine changes to the system, determine a new set of service design selection solutions, and reconfigure the system accordingly.

In summary, one aspect provides a method for selecting a service design solution for one or more business processes comprising: accessing a library of shared services for a shared environment of services; mapping one or more business processes to one or more services of the library of shared services; identifying a set of service selection design solutions for the one or more business processes using a combinatorial selection technique; ascertaining a selection indicating one of the set of service selection design solutions; and modifying an aspect of the shared environment of services responsive to said selection.

Another aspect provides a computer program product for selecting a service design solution for one or more business processes comprising: a computer readable storage medium having computer readable program code embodied therewith, the computer readable program code comprising: computer readable program code configured to access a library of shared services for a shared environment of services; computer readable program code configured to map one or more business processes to one or more services of the library of shared services; computer readable program code configured to identify a set of service selection design solutions for the one or more business processes using a combinatorial selection technique; computer readable program code configured to ascertain a selection indicating one of the set of service selection design solutions; and computer readable program code configured to modify an aspect of the shared environment of services responsive to said selection.

A further aspect provides a system for selecting a service design solution for one or more business processes comprising: one or more processors; and a memory operatively connected to the one or more processors; wherein, responsive to execution of computer readable program code accessible to the one or more processors, the one or more processors are configured to: access a library of shared services for a shared environment of services; map one or more business processes to one or more services of the library of shared services; identify a set of service selection design solutions for the one or more business processes using a combinatorial selection technique; ascertain a selection indicating one of the set of service selection design solutions; and modify an aspect of the shared environment of services responsive to said selection.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates a shared services environment.

FIG. 2 illustrates examples of problem solutions.

FIG. 3(A-C) illustrates example process designs.

FIG. 4 illustrates an example of a library of shared services and their cost characteristics.

FIG. 5 illustrates an example system for dynamically optimizing business processes based on shared services.

FIG. 6 illustrates an example of a service performance log table.

FIG. 7 illustrates example approaches for handling system changes.

FIG. 8 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid obfuscation.

The description now turns to the figures. The illustrated example embodiments will be best understood by reference to the figures. The following description is intended only by way of example and simply illustrates certain selected example embodiments representative of the invention, as claimed.

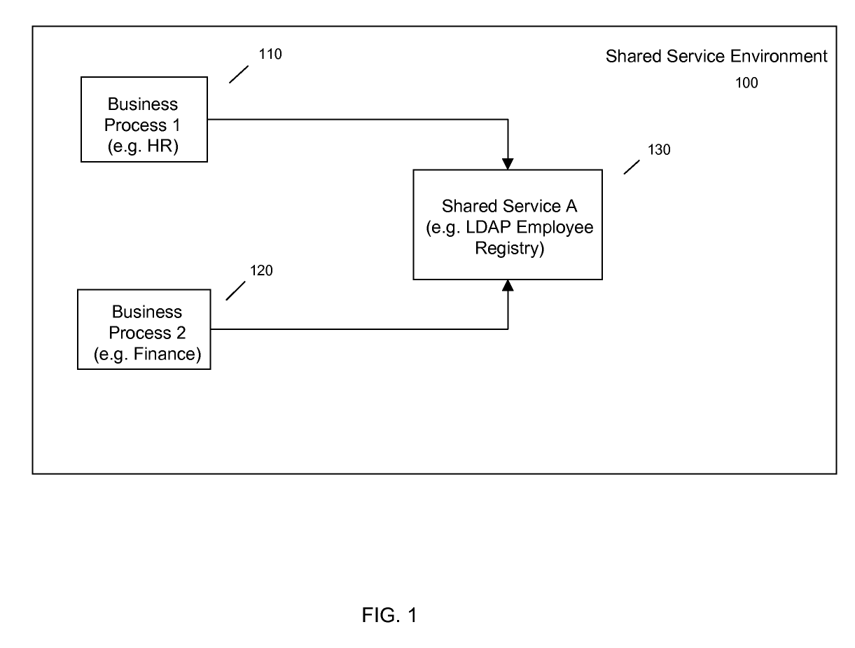

In a shared services environment 100 such as that illustrated in FIG. 1, multiple applications/business processes 110, 120 running on the same cloud may require use of the same service(s) 130. For example, an HR business process 110 and a finance business process 120 may each require authentication services, and so may each make a call to an LDAP service 130 for employee log in.

Moreover, the QoS (for example, response time) parameters for the business process(es) 110, 120 often are effected with changes to the system, such as addition of a new service or replacement of an existing service in the shared environment 100. Such changes to the system include but are not limited to addition of new processes, and can include for example changes in the end-to-end QoS constraints for a process (as represented by operational level agreements (OLAs)), addition or deletion of services from a shared library of services, an increase in traffic/load in some or all processes, and missed OLAs (violations) for one or more processes.

The problem of service selection is then to match services for a given business process that satisfies the QoS requirements. The matching problem becomes complex due to, for example, the following confounding factors.

The search space (number of possible services) is combinatorial. For example, given a simple business process of five tasks/activities, and with five alternate services available for each activity, the search space is 5⁵. This is incomprehensible for a human to enumerate and decide the best services to match to the tasks of the process.

The problem of service selection is also multi-objective in nature due to the presence of multiple, often conflicting QoS requirements specified by multiple business processes accessing the set of shared services. Thus, in addition to handling the combinatorial nature of services available (search space), a solution to a multi-objective optimization problem is needed.

One such solution is to discover the set of Pareto optimal solutions where improvement in one objective can occur only with the worsening in at least one other objective. The Pareto optimal set defines the best matching solutions that can be provided to the system administrator for picking a match. Alternatively, business rules can be defined to select a solution from the Pareto optimal set automatically.

Moreover, the shared services are accessed in a shared mode, that is, multiple business processes can concurrently access the same service, as shown in FIG. 1. The service selection should therefore adhere to the QoS requirements by taking into account a service load. This imposes an additional constraint on the multi-objective optimization problem to consider the load when allocating a service to multiple business processes.

Existing solutions have not addressed the problem of service selection considering all of the above factors. Global planning approaches have applied mixed integer linear programming for solving the optimization problem, but convert the multiple-objective problem into a single-objective problem by assigning weights to objectives. This setting limits the discovery of Pareto optimal solutions. Other techniques were found to output sub-optimal results, although better than linear programming. Reinforcement learning used for QoS optimization applies local strategy and thus is limited in its ability to discover the Pareto optimal solutions. Simple evolutionary approaches have been used for the multi objective service selection problem, but by combining the multiple objectives into single objective function after assigning weights to each objective. All these approaches return a single solution to the user (for example, a system administrator) and thus do not provide coverage of the Pareto front (set of optimal solutions). In addition, the existing solutions do not consider a shared environment and the service load factor it introduces.

Thus, for multiple business processes running in a shared environment, existing service selection approaches suffer from poor convergence to global optimal solutions owing to local optimization methods. Additionally, existing methods focus on service selection for a single business process and do not consider a load factor for a service that is an important constraint in a shared environment (that is, where the service(s) are utilized by multiple processes).

Accordingly, embodiments provide solutions to such problems by discovering optimal set(s) of service designs/selections. A system administrator is then provided with a set of designs that optimize composition of business processes in a shared environment. Embodiments also provide dynamic feedback to quickly and appropriately handle newly introduced changes to the system.

Embodiments apply a combinatorial selection approach, such as a population-based search optimization approach, that addresses the confounding factors mentioned above and identifies a Pareto set of service design solutions. As used herein, a population-based search optimization process is one with multiple objective optimization capabilities and the ability to manage combinatorial search spaces. As a non-limiting example, an evolutionary-based search optimization process is described herein. However, those having ordinary skill in the art will recognize that other combinatorial or population-based search optimization processes can equally be utilized, for example a particle swarm optimization approach or an ant colony optimization approach. Moreover, the examples discussed herein focus on identifying the Pareto optimal set of service design solutions; however, this is by no means limiting. Any reasonable threshold (for example, fitness criteria for a population-based selection approach) for identifying a limited number of solutions that optimize or at least improve to some degree one or more objectives (that is, a set or an “optimal” set of solutions) can be utilized to suit a particular use context contemplated, even if the set of solutions includes solutions that do not strictly fall within a Pareto-optimal set.

Using a population-based search optimization process, embodiments map the service selection problem into a population-based selection problem having Pareto optimality as the fitness criteria. Evolutionary algorithms are popular for solving multi-objective optimization problems when they apply Pareto optimality based fitness schemes, and the population-based approach is good in finding a set of solutions as opposed to single solution.

An example of an evolutionary population-based search optimization process is a genetic optimization process. A genetic optimization process is inspired by the principle of natural selection. The basic idea is to evolve a population of abstract representations (chromosome, genotype or genome) of candidate solutions (also called phenotypes), towards better solutions. Each phenotype is evaluated by a fitness function, which measures the quality of its corresponding solution.

Evolutionary population-based search optimization processes are considered well-suited for service selection problems when compared to traditional optimization methods because of their ability to search for multiple solutions in parallel and to handle complicated search spaces (of large size) with discontinuities, multi-modalities and noisy data points. The population-based approach in genetic optimization processes lead to effective search and better chances of finding a globally optimal solution.

Broadly speaking any evolutionary search process is characterized by following steps:

Pseudo code for Simple evolutionary search process:

| | |
|---|---|
| 1) | Establish a genotypic representation of the candidate solution. |
| | Establish a selection procedure to define selection probability for |
| | each phenotype in P(t). |
| 2) | Randomly initialize a population P(0) of fixed size. |
| 3) | Compute and save fitness of each phenotype fi in the population P(t). |
| 4) | Select two phenotypes from P(t) on the basis of their selection |
| | probability. |
| 5) | Apply crossover operator as per crossover probability on the two |
| | candidates to produce offspring (candidate solutions for next |
| | generation). |
| 6) | Mutate the offspring as per the mutation probability. |
| 7) | Put the two phenotype into next Population P(t + 1). |
| 8) | Repeat steps 4 to 7 until number of phenotypes in P(t + 1) equals the |
| | population size. |
| 9) | Repeat from step 3 on resulting population P(t + 1) until maximum |
| | generation is reached or no improvement in fitness is observed. |

In the real world the designer is faced with multiple, often competing, objectives that should be optimized simultaneously. While satisfying one of these objectives, other objectives have to be compromised. Also these objectives can interact or conflict with each other, increasing one can reduce others. The competing objectives in a multi objective problem are often satisfied with what is called the notion of Pareto-optimality.

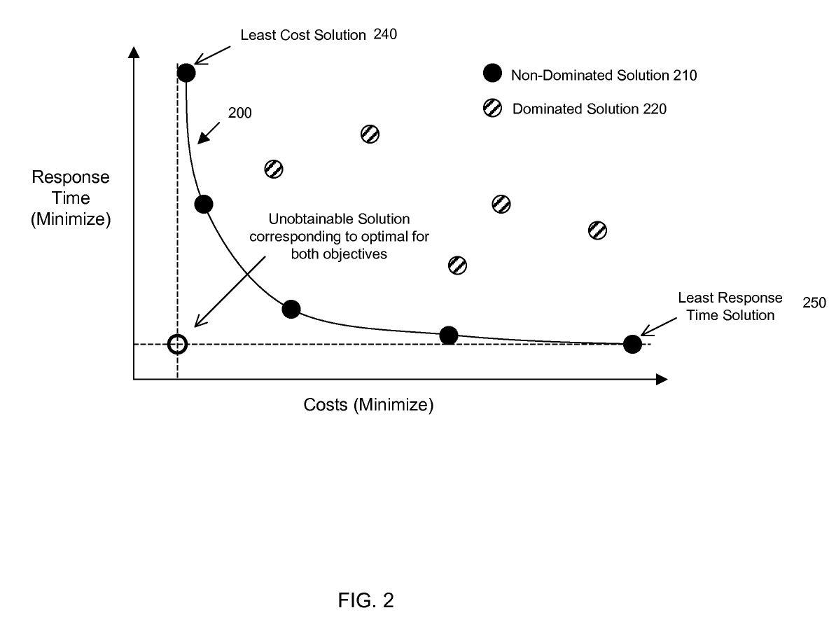

Referring to FIG. 2, Pareto-optimality is a measure of efficiency in multi-criteria situations and therefore has wide applicability in economics, game theory, and multi-objective optimization. In order to identify Pareto optimal solutions the concept of dominance is used. For a problem having more than one objective, for example minimizing response time and minimizing costs, as illustrated in FIG. 2, any two solutions (x₁ and x₂) can have one or two possibilities between them: one dominates the other, or none dominates the other.

A solution x₁ is said to dominate x₂ if both these conditions are satisfied: The solution x₁ is no worse than x₂ in all objectives; and the solution x₁ is strictly better than x₂ in at least one objective.

A Pareto optimal solution set (represented by a Pareto front 200) consists of non dominated solutions 210, that is, no two solutions in that set dominate each other, and each solution in the set dominates all solutions 220 outside the set. The population-based approach in is well suited for multi-objective optimization where satisfaction of multiple, often conflicting, objectives (such as minimizing cost and response time) necessitates generation of multiple solutions in order to give designer/system administrator a choice in the presence of trade off. For example, in FIG. 2, a least cost solution 240 is divergent from a least response time solution 250.

Multi Objective Genetic Algorithms (MOGAs) are popular because of their ability to find a wide spread of Pareto-optimal solutions 200 in a single simulation run. Several MOGAs such as NSGA (Non-dominated sorting Genetic Algorithm) and SPEA (Strength Pareto Evolutionary Algorithm) use the concept of dominance for ranking.

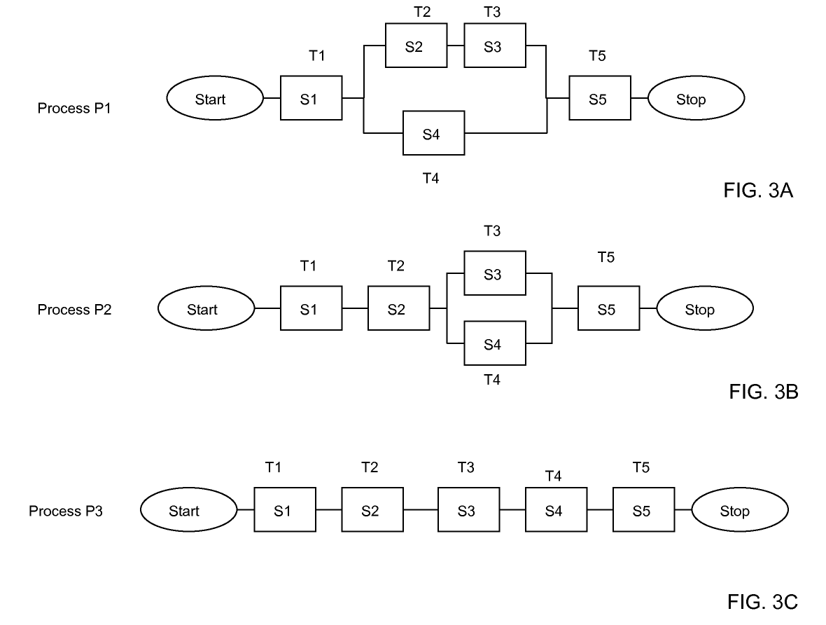

Referring to FIG. 3(A-C), the problem of service selection is formulated for the process of service selection with end-to-end QoS constraints on processes using a shared services library. FIG. 3(A-C) shows three composite business processes (P₁, P₂, and P₃) each consisting of five tasks (T₁ to T₅), with each task mapped to a service class (S₁ to S₅). For example, task Tᵢ is mapped to service class Sᵢ where 1<=i<=5.

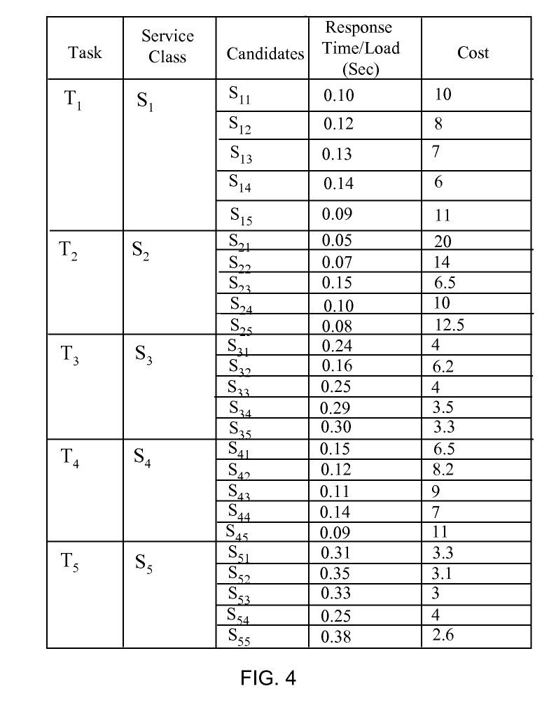

Each task Tᵢ may be executed by any service (Sᵢⱼ) in the service class Sᵢ. Candidate services in each class are associated with their QoS parameters (cost and response time/load) such as shown in FIG. 4. The example values for “Response-Time/Load” ratio in FIG. 4 (such as prescribed by the service provider) were generated randomly to provide an example. Since the cost is generally higher for services with better response time, the cost values as shown in FIG. 4 are the inverse of the “Response-Time/Load” ratio.

Most commonly cited QoS parameters at the service level are execution time, cost, availability, and reliability. Parameters such as cost, availability and reliability are mostly static and hence deterministic. On the contrary, assuming a fixed value for execution time of each service candidate is generally an idealistic approach. In reality the execution time would vary as per the load on the service candidate.

The possible number of solutions (search space) is quite large in the shared environment. Considering just one process being executed on the shared library, the number of possible combinations in which services could be selected for the process is:

Πᵢ₌₁ⁿ|Si|

where |Si| is the cardinality, that is, the number of services which can serve i^{th} task, and n is the number of tasks. The multiplication therefore represents the size of search space of possible solutions, with dimensionality of search space being equal to n, that is, the number of tasks. This number will increase exponentially as new business processes are on-boarded on the same shared library of services. Consider for example when the Process P₂ in FIG. 3B is on-boarded assuming P₁ is already running, the effective number of tasks will be 10, and therefore the size of search space will be:

Πᵢ₌₁¹⁰|Si|

For each of the composite business process, the objective function values for time are as calculated as shown below:

$${T}_{Pi} = {\sum }_{j = 1}^{n} {L}_{{j}^{′}} \times {( R / L )}_{{j}^{′}} \qquad ( a )$$

where T_{P}_{ᵢ} is the end to end response time for process P_{i.} and (R/L)_{j′} is the time to load ratio for the selected service in service class j. Similarly, L_{j′} denotes the load on selected service from class j. Note that L_{j′} is the sum of load values for each business process that is using the selected service in class j. For instance, if the load on business processes P₁ and P₂ be respectively 100 and 50, and assuming that both the processes use the same service S₂₁ from service class S₂, the value of L_{2′} will be 100+50. In case the composition structure has a AND split (fork), then at the AND join the maximum of response time from each branch should be considered, while in case of XOR split a probabilistic model can be used for computation.

For the processes Pᵢ the cost associated is given by:

$${C}_{Pi} = {L}_{1} \times {\sum }_{j = 1}^{n} {C}_{{S}_{jj}} , \qquad ( b )$$

where Lᵢ is the load associated with the business process Pᵢ and C_{S}_{ⱼⱼ}_{′} is the cost associated with the service selected from service class j.

The QoS service selection problem is to select one service candidate from each service class to construct a composite business process that meets a process's QoS constraints and achieves defined objectives in the best possible manner. As a non-limiting example scenario, assume that the overall end-to-end QoS objective for a process is the minimization of response time, while the overall QoS constraint is on the cost. The problem is single objective in nature when just one process is using the shared service library; however, with the introduction of new processes it becomes multi-objective in nature. It should also be noted that the problem of service selection is combinatorial in nature and increases in complexity with the introduction of further services in one or more classes or with the introduction of more tasks or with the introduction of more business processes using the same shared library.

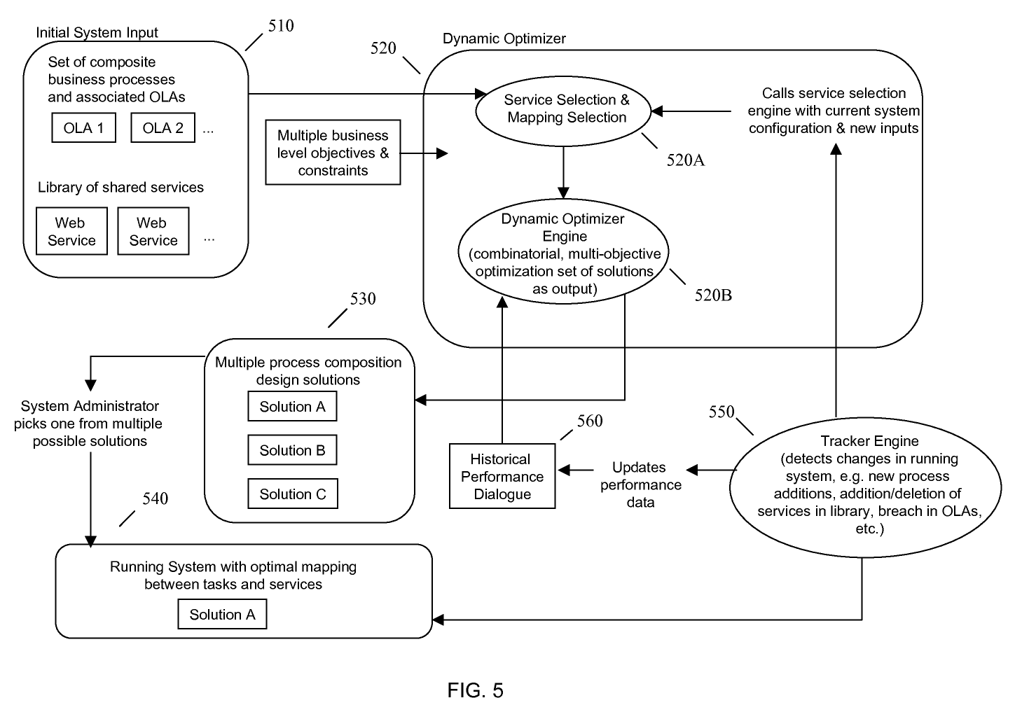

Referring to FIG. 5, embodiments employ a system including a dynamic optimizer to manage the service selection problem in a shared environment. As initial input 510 to the system, sets of business processes and corresponding OLAs are provided, along with a shared library of services (for example, web services) supporting the business processes. A dynamic optimizer module 520 provides a service selection and mapping module 520A as well as a dynamic optimizer engine 520B. The service selection and mapping module 520A takes the input and maps available services to the business processes. The dynamic optimizer engine 520B selects an optimal set of solution designs for service selection, given the available services, the business processes input, and any constraints. The set of solutions can include a set of combinatorial and multi-objective solutions. These are provided as output 530, for example to a system administrator for selection. The system administrator is then enabled to select from the set of solutions an appropriate service selection design to run 540 the business processes. In the alternative, the system can automatically select a solution from the optimal set automatically, as for example according to one or more predetermined rules.

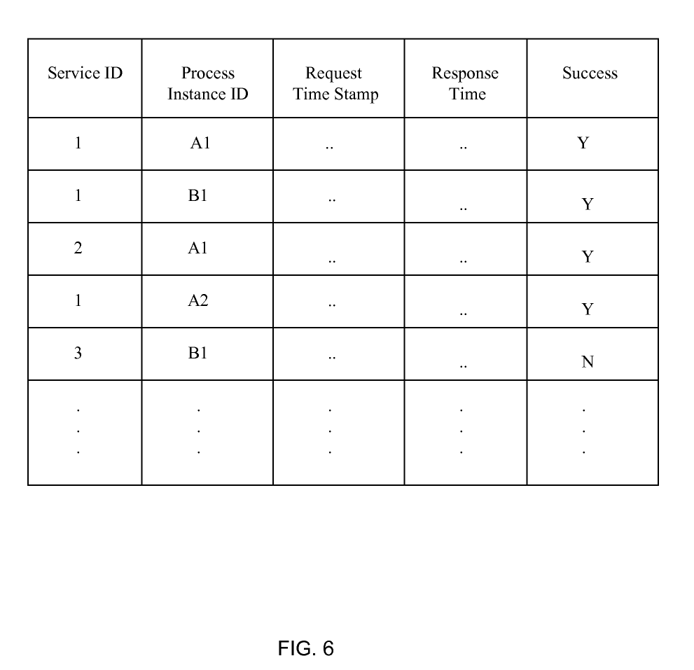

A tracking engine 550 additionally tracks any changes to the system, such as the addition of a new service, and reports these events to the service selection and mapping module 520A. The service and mapping module 520A in turn can report this to the dynamic optimizer engine 520B, which, given the changes to the system (for example, new service(s) mapped to the business processes), can again identify a set of optimal service selection solutions to provide as output. Moreover, a historical performance dialogue module 560 logs service performance in a log table (refer to FIG. 6), which can also be utilized as input on system performance by the dynamic optimizer engine 520B. Thus, embodiments enable simplified selection of services for business processes given a large amount of potential service solutions.

As illustrated in FIG. 6, embodiments maintain a log table to track the performance of services of various business processes in the shared environment. A service performance characteristic, such as response time per load on a service or success/failure of a service to perform as per an OLA, can be determined dynamically given the data in the log table. The characteristics of the services in the shared library (FIG. 4) can be updated accordingly. Thus, given changes in service performance characteristics, the system can be reconfigured to use another optimal solution.

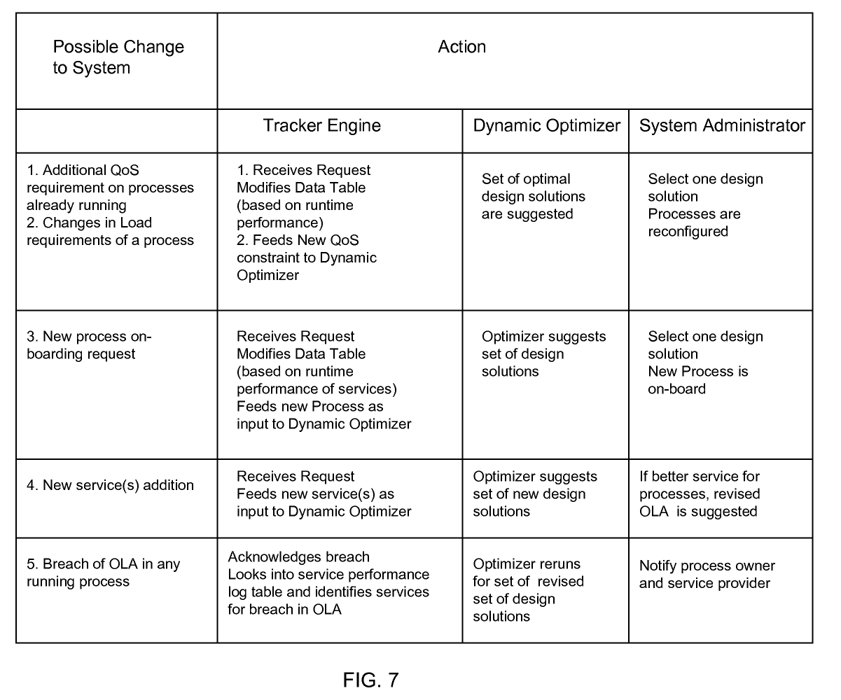

Performance characteristics of services in the shared library can be impacted by changes to the system. FIG. 7 illustrates some example changes that may occur and some possible example system reactions and solutions in response thereto. For example, in response to new constraints on a process, the tracking engine 550 acknowledges the change and updates the dynamic optimizer engine 520B. The dynamic optimizer engine 520B produces as output an updated set of possible service design selections 540 from which a system administrator can choose. Similarly, if a new processes is to be on-boarded or a breach of an OLA occurs, the tracking engine 550 informs the dynamic optimizer engine 520B, which produces a new set of solutions for the system administrator.

To highlight aspects of embodiments handling of the QoS service selection problem, example embodiments run using test scenarios with incremental complexity are described herein. These test scenarios were created using one or more processes from FIG. 3(A-C) and using the example shared services library illustrated in FIG. 4. In each test scenario, all possible solutions were enumerated in order to facilitate the comparison of results. The process load for each of the process was kept at 100 instances per second. Note that the choice of 100 is completely arbitrary.

For the test scenarios, a genetic search optimization approach was employed for a test scenario with single objective (for example, time), while a specific search optimization approach (NSGA-II) was applied for test scenarios with multiple objectives (cost and time). It should again be noted that although specific population-based search optimization approaches (for example, NSGA-II) were utilized, embodiments are equally capable of utilizing other population-based search optimization approaches, for example particle swarm and ant colony approaches.

In each generation, the top 10% of solutions from the population were preserved and stored in a separate cluster for the genetic search optimization approach. Effectiveness of the genetic search approach was measured by comparing the solutions in the cluster at end of each run with the global best solutions identified after complete enumeration of the search space.

For multiple objectives (for example, minimization of both cost and time), a refinement of NSGA, NSGA-II, was used. This refinement uses elitism and a concept of crowding distance to maintain diversity in each Pareto front. The refinement is briefly discussed below.

During the selection stage phenotypes in the population were checked against each other and assigned into Pareto fronts. Once the phenotypes of the first non-dominated front were found they were discounted in the comparison, and phenotypes of the next front were identified. The process repeated to identify all fronts. The solutions in the first front had the largest chance in selection. In order to preserve diversity, solutions in each front were ranked according to their crowding distance. Crowding distance is a criterion to measure how close a solution is to its neighbors. A solution with higher crowding distance was given a higher rank. The pseudo code for NSGA-II is given below:

| | |
|---|---|
| 1. | Initialize the population |
| | Sort the phenotypes according to the non-dominated fronts |
| | In each front rank the phenotypes according to the crowding distance |
| | criterion |
| 2. | Generate the offspring population using the mutation and crossover |
| | Combine the population (both the parent and offspring) |
| | Sort phenotypes according to the non-dominated fronts, Assign rank in |
| | each front according to crowding distance criterion |
| | Produce the new population by means of fronts according to the front's |
| | rank |
| 3. | Repeat - from step 2 until a fixed number of iteration has been |
| | accomplished |

The open source genetics package in Java from Apache Commons was used for development. It provides a framework and implementation for Genetic Algorithms. A chromosome represents a legal solution to the problem and consists of a string of genes. Example embodiments used in the test scenarios employed a string of integer values with length equal to the number of tasks. The value at each gene corresponded to a particular service from the set of available services for the task.

Five test scenarios were created to test an example approach. QoS parameters from FIG. 4 were used in each. The approach was tested (test scenario I) starting with just one process (P₁) with optimizing the end-to-end execution time per instance (single objective). Changes to the shared services environment (such as introduction of a constraint or addition of one or more processes, as described herein) were then introduced such that the system would require reconfiguration. In test scenario II, the minimization of end-to-end cost was introduced as a second objective. Process P₂ was on-boarded in test scenario III, and the objectives on minimization of end-to-end response time for both P₁ and P₂ were solved. Test scenario IV added cost constraints on both P₁ and P₂ while keeping the minimization of response time as two objectives. Finally in test scenario V, the process P₃ was on-boarded and minimization of end-to-end response time for all three processes was kept as the objective. Each of the test scenarios is described briefly below.

Test Scenario I

Process P₁ was run using the shared library of services. The search space size was set to =5⁵=3125. As the sole objective, minimization of total execution time per instance as given by equation (a) was chosen. The global best solutions included solutions in the entire search space that were enumerated using equation (a) and global minimum response time was identified as 55 seconds (assuming process Load of 100 instances per sec). There were five solutions identified (that mapped to it). The five solutions were (referring to FIG. 2A and FIG. 3):

{S₁₄,S₂₀,S₃₁,S₄₀,S₄₃}, {S₁₄,S₂₀,S₃₁,S₄₂,S₄₃}, {S₁₄,S₂₀,S₃₁,S₄₂,S₄₃}, {S₁₄,S₂₀,S₃₁,S₄₄,S₄₃}, {S₁₄,S₂₀,S₃₁,S₄₄,S₄₃}.

A genetic based search approach was used with a population size and number of generations kept at 20 each. Single point crossover with a crossover rate of 0.7 and variable mutation rates starting with 0.6 and slowly decreasing to 0.1 were used. Tournament selection was used with a tournament size of 3.

Results: 50 runs of simple genetic optimization process with these settings were initiated and the solutions from the cluster after each run were checked against the five global best solutions. In all the runs, the five best solutions were present in the cluster.

Test Scenario II

Process P₁ was again run using the shared library of services with the same parameters as in test scenario I; however, two objectives (minimization of total execution time as well as cost per instance as given by equation (a) and (b), respectively) were used. Moreover, NSGA-II was used was used as the population-based search approach.

Global best solutions: Solutions in entire search space were enumerated using equation (a) and (b) and Pareto optimal solutions were identified. A set of 22 solutions were found to be Pareto optimal. Only one out of five optimal solutions in terms of response time (test scenario I) was in the set of 22 solutions indicating that cost was a conflicting objective compared to response time.

NSGA-II was used with population size and number of generations kept at 20 each. Single point crossover with a crossover rate of 0.7 and tournament selection with tournament size of 3 was used. Mutation rate was kept fixed at 0.4. Dominance as defined by Pareto Optimality was used as a fitness function.

Results: 50 runs of NSGA-II were initiated and the solutions from the identified Pareto front were checked against the 22 solutions in the actual Pareto front. The mean number of solutions found was 17.62 with a standard deviation of 2.30.

Run results reveal that for response time and cost as two objectives, certain service candidates in each class are high performing since they are regularly selected at the end of each run. Also it could be observed that all services in class S₁ were found in the Pareto solution set. This means that the overall response time and cost for the process is less sensitive to service selection from service class S₁ and more sensitive to selection from other service classes.

Such an analysis gives a quick insight into the service distribution in high quality solutions. Presenting such results to an administrator gives the administrator further insight into variable interaction and dependency relation between the overall QoS objective in question and the associated variables.

Test Scenario III

Processes P₁ and P₂ were run with a search space size set to 5¹⁰=9765625. The objective was the minimization of execution time per instance, but for both the processes (where execution time per instance is given by equation (a)). Again, NSGA-II was used, but with population size and number of generations kept at 100 and 1000 respectively. Other settings were kept same as in previous test scenarios.

At the time the Process P₂ is on-boarded, the service selection problem for P₂ should not be solved in isolation because doing so may result in drop in performance for P₁, as well as not giving expected performance for P₂. Satisfying the objectives in both the processes requires trade off solutions given by the Pareto front such that the designer can pick and choose the ones that best satisfy the operational level end-to-end requirements on response time requirements for both the processes (as may have been entered in the OLA).

To evaluate the efficacy, the entire set of 9765625 solutions was enumerated and Pareto optimal solutions were identified from the complete enumeration. 332 solutions were found in the global Pareto front.

Result: 50 runs were performed to identify Pareto optimal solutions. The mean number of solutions found was 290.6 with a standard deviation of 15.48, minimum value of 249 and maximum value of 313.

Test Scenario IV (Handling Constraints)

Further to managing multiple objectives, several constraints can be added to the system that require reconfiguration. Handling constraints using a genetic search optimization approach is a well-studied subject and various heuristics are used for assigning a penalty to a solution violating one or more constraint. In the refinement to the NSGA-II (used in certain test scenarios and as described herein), a severe penalty approach was taken, where a solution would be given the lowest fitness in the population if it violated any of the required constraint(s). This minimizes the chances of survival for such a solution and therefore the chances of it getting into the next generation.

Processes P₁ and P₂ were run with a search space size set to 5¹⁰=9765625. Here, the objective was the minimization of execution time per instance for both processes P₁ and P₂ (where execution time per instance is given by equation (a)). The constraints added in this example were cost per instance for P₁<45; cost per instance for P₂<40. From previous test scenario examples, it is known that there are 332 Pareto optimal solutions with respect to execution time. Enumerating those with respect to cost per instance for P₁ and P₂ as given by equation (a), it was observed that only 76 satisfied the required constraints. NSGA-II was used with the same settings as in the previous two test scenarios, with introduction of the severe penalty for solutions violating the constraints.

Result: 50 runs were performed to identify Pareto optimal solutions that additionally satisfy the required cost constraints. The mean number of solutions found was 69, with a standard deviation of 5.832. The results indicate the efficacy of this example constraint handling approach to satisfy multiple constraints in conjunction with the NSGA-II approach.

Test Scenario V

In this test scenario, processes P₁, P₂ and P₃ were run, with the search space size set to 5¹⁵=˜30.5×10⁹. Here the objectives were to minimization response time for all three processes P₁, P₂ and P₃. NSGA-II was used with population size and number of generations kept at 100 and 10,000 respectively. Other settings were kept same as in previous test scenarios. To evaluate the efficacy of approach, the entire set of 30.5×10⁹ solutions was enumerated and Pareto optimal solutions were identified from the complete enumeration. 1742 solutions were found in the global Pareto front.

Results: 50 runs were performed to identify Pareto optimal solutions. The mean number of solutions found was 1625.4 with a standard deviation of 40.32, minimum value of 1509 and maximum value of 1705.

In brief recapitulation, embodiments map the optimal service selection problem into an evolutionary computation problem. Certain example embodiments have been described herein with connection to a non-limiting test application of (refined) NSGA-II evolutionary search processing for finding Pareto optimal solutions for service selection in shared services environment. Embodiments benefit from the strength of genetic search optimization in achieving global optimization. The test scenarios presented herein demonstrate the significant improvement in discovering the number of Pareto optimal solutions (for example as compared to reinforcement learning, a widely used service selection technique).

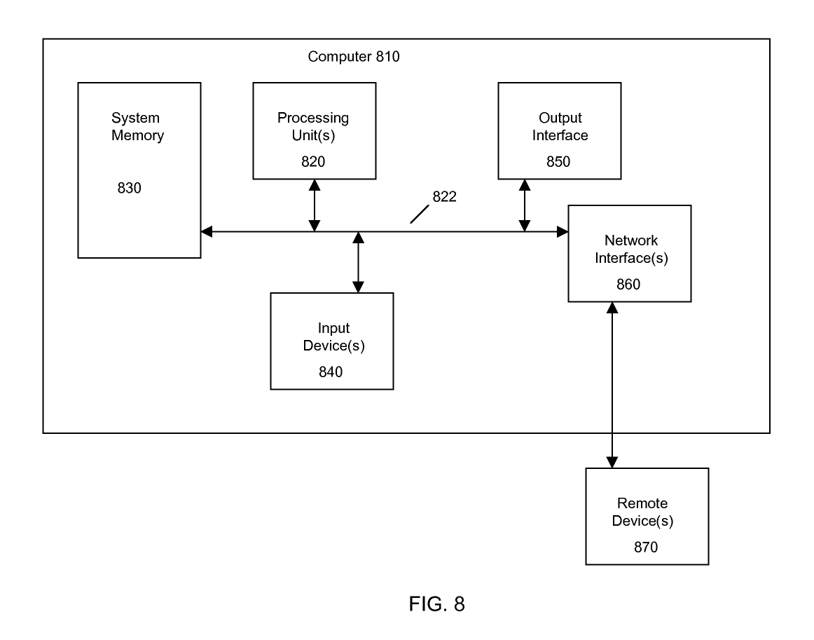

Referring to FIG. 8, it will be readily understood that certain embodiments can be implemented using any of a wide variety of devices or combinations of devices. An example device that may be used in implementing one or more embodiments includes a computing device in the form of a computer 810. In this regard, the computer 810 may execute program instructions configured to map one or more business processes to one or more services, identify optimal set(s) of service design solutions from a shared services library, and perform other functionality of the embodiments, as described herein.

Components of computer 810 may include, but are not limited to, a processing unit 820, a system memory 830, and a system bus 822 that couples various system components including the system memory 830 to the processing unit 820. The computer 810 may include or have access to a variety of computer readable media. The system memory 830 may include computer readable storage media in the form of volatile and/or nonvolatile memory such as read only memory (ROM) and/or random access memory (RAM). By way of example, and not limitation, system memory 830 may also include an operating system, application programs, other program modules, and program data.

A user can interface with (for example, enter commands and information) the computer 810 through input devices 840. A monitor or other type of device can also be connected to the system bus 822 via an interface, such as an output interface 850. In addition to a monitor, computers may also include other peripheral output devices. The computer 810 may operate in a networked or distributed environment using logical connections to one or more other remote computers or databases. The logical connections may include a network, such local area network (LAN) or a wide area network (WAN), but may also include other networks/buses.

It should be noted as well that certain embodiments may be implemented as a system, method or computer program product. Accordingly, aspects may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for various aspects may be written in any combination of one or more programming languages, including an object oriented programming language such as Java™, Smalltalk, C++ or the like and conventional procedural programming languages, such as the “C” programming language or similar programming languages. The program code may execute entirely on a single computer (device), partly on a single computer, as a stand-alone software package, partly on single computer and partly on a remote computer or entirely on a remote computer or server. In the latter scenario, the remote computer may be connected to another computer through any type of network, including a local area network (LAN) or a wide area network (WAN), or the connection may be made for example through the Internet using an Internet Service Provider.

Aspects are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A method for selecting a service design solution for one or more business processes comprising:
accessing a library of shared services for a shared environment of services;
mapping one or more business processes to one or more services of the library of shared services;
identifying a set of service selection design solutions for the one or more business processes using a combinatorial selection technique;
ascertaining a selection indicating one of the set of service selection design solutions; and
modifying an aspect of the shared environment of services responsive to said selection.

2. The method according to claim 1, wherein identifying a set of service selection design solutions for the one or more business processes using a combinatorial selection technique comprises using a population-based optimization technique.

3. The method according to claim 1, wherein the combinatorial selection technique is selected from a group of techniques consisting of: a technique for simultaneously optimizing one or more objectives for a plurality of business processes, a technique for simultaneously optimizing a plurality of objectives for a business process, and a technique for simultaneously optimizing a plurality of objectives for a plurality of business processes.

4. The method according to claim 1, wherein the combinatorial selection technique comprises a genetics-based selection technique.

5. The method according to claim 1, wherein the set of service selection design solutions comprises a Pareto-optimal set of service selection design solutions.

6. The method according to claim 1, further comprising tracking one or more changes to the shared environment of services.

7. The method according to claim 6, wherein the one or more changes to the shared environment of services comprise one or more of changes to services of the library of shared services and changes to one or more business processes.

8. The method according to claim 7, further comprising, responsive to determining one or more changes to the shared environment of services, reconfiguring the shared environment of services via implementing a new service selection design for the one or more business processes.

9. A computer program product for selecting a service design solution for one or more business processes comprising:
a computer readable storage medium having computer readable program code embodied therewith, the computer readable program code comprising:
computer readable program code configured to access a library of shared services for a shared environment of services;
computer readable program code configured to map one or more business processes to one or more services of the library of shared services;
computer readable program code configured to identify a set of service selection design solutions for the one or more business processes using a combinatorial selection technique;
computer readable program code configured to ascertain a selection indicating one of the set of service selection design solutions; and
computer readable program code configured to modify an aspect of the shared environment of services responsive to said selection.

10. The computer program product according to claim 9, wherein to identify a set of service selection design solutions for the one or more business processes using a combinatorial selection technique comprises using a population-based optimization technique.

11. The computer program product according to claim 9, wherein the combinatorial selection technique is selected from a group of techniques consisting of: a technique for simultaneously optimizing one or more objectives for a plurality of business processes, a technique for simultaneously optimizing a plurality of objectives for a business process, and a technique for simultaneously optimizing a plurality of objectives for a plurality of business processes.

12. The computer program product according to claim 9, wherein the combinatorial selection technique comprises a genetics-based selection technique.

13. The computer program product according to claim 9, wherein the set of service selection design solutions comprises a Pareto-optimal set of service selection design solutions.

14. The computer program product according to claim 9, further comprising computer readable program code configured to track one or more changes to the shared environment of services.

15. The computer program product according to claim 14, wherein the one or more changes to the shared environment of services comprise one or more of changes to services of the library of shared services and changes to one or more business processes.

16. The computer program product according to claim 15, further comprising computer readable program code configured to, responsive to determining one or more changes to the shared environment of services, reconfiguring the shared environment of services via implementing a new service selection design for the one or more business processes.

17. A system for selecting a service design solution for one or more business processes comprising:
one or more processors; and
a memory operatively connected to the one or more processors;
wherein, responsive to execution of computer readable program code accessible to the one or more processors, the one or more processors are configured to:
access a library of shared services for a shared environment of services;
map one or more business processes to one or more services of the library of shared services;
identify a set of service selection design solutions for the one or more business processes using a combinatorial selection technique;
ascertain a selection indicating one of the set of service selection design solutions; and
modify an aspect of the shared environment of services responsive to said selection.

18. The system according to claim 17, wherein the set of service selection design solutions comprises a Pareto-optimal set of service selection design solutions.

19. The system according to claim 17, wherein the combinatorial selection technique comprises a genetics-based selection technique.

20. The system according to claim 11, wherein the one or more processors are further configured to, responsive to determining one or more changes to the shared environment of services, reconfigure the shared environment of services via implementing a new service selection design for the one or more business processes.
